(19) United States
(12) Patent Application Publication
(10) Pub. No.: US 2003/0174946 A1
(43) Pub. Date: Sep. 18, 2003

(54) Superstructure photonic band-gap grating add-drop filter

(76) Inventor: Jean-Francois Viens, Boston, MA (US)

Correspondence Address: Att: Matthew E. Connors, Samuels, Gauthier & Stevens, LLP, Suite 3300, 225 Franklin Street, Boston, MA, 02110, US

(21) Appl. No.: 10/098,577

(22) Filed: Mar. 14, 2002

(51) Int. Cl. G02B 6/34; G02B 6/26

(52) U.S. Cl. 385/37; 385/27

(57) ABSTRACT

A large bandwidth add-drop filter for a planar waveguide device including at least one coupler that receives an input signal and provides an output signal and a least two grating waveguides having a photonic band gap covering at least 4 optical channels. In some embodiments, the gratings have a superstructure grating strength profile to provide a spectral interleaver. In other embodiments, the gratings have a sampled grating strength profile to provide a spectral slicer. Presently, two direction couplers are used. One coupler provides an input port and a drop port and the other provides an add port and a transmission port.

### BACKGROUND OF THE INVENTION

Signal routing is a key component of high bandwidth wavelength division multiplexing (WDM) communication systems. Signal routing involves the adding and/or dropping of optical channels from an optical transmission line. WDM communication systems require efficient adding and/or dropping of multiple optical signals with low signal distortion and low channel crosstalk. Photonic add-drop devices whose filter characteristics can be configured to perform spectral slicing, spectral de-interleaving and channel-specific spectral filtering, over large bandwidths, are an enabling technology for exploiting the full bandwidth potential of WDM communication systems. Generally, a filtering function is said to have a large war, bandwidth, or to be broadband, if both the optical feedback and optical interference effects cover a spectral range equivalent to multiple optical channels of interest, specifically four (4) its channels or more.

In spectral slicing, a continuous band of optical channels are added to or dropped from a transmission line. For example, a WDM signal including C and L band optical channels is split (“sliced”) into two WDM signals, one with only C band optical channels and another with only L band optical channels. Slicing can also be used to separate upper optical channels from lower frequency optical channels within a given band, such as the C band.

In spectral interleaving/de-interleaving devices, comb-like filter function devices are used to separate odd optical channels from even optical channels, for example. Coarser granularity devices may separate alternating multi-channel blocks from each other. Finer granularity devices may separate periodically one specific channel out of every Nth channels.

In channel-specific spectral filter devices, specific channels or band of channels are added to or dropped from a transmission line. The selected optical channels are not limited to bands of channels like the spectral slicer, or to alternating blocks of channels like the de-interleaver, but may be a combination of several of these items to provide custom channel-per-channel filtering characteristics.

Presently, wide band filtering is generally implemented using either interference filters fabricated using thin film filter technology, or ring resonators fabricated using planar waveguides, or Mach-Zehnder interferometers fabricated using coupled fibers. In thin film filters, alternating high and low refractive index material layers in combination with Fabry-Perot cavities are typically formed on substrate. By careful design and control of the deposition processes, desired filtering functions can be achieved. Wide band ring resonators are fabricated by forming relatively small waveguide rings. Typically serial or parallel combinations of ring resonators are used to achieve the desired filter shape. Mach-Zehnder interferometers are formed by joining two optical fibers in a side-coupled fashion, the spliced regions defining directional couplers and the non-spliced regions defining optical delay lines.

### SUMMARY OF THE INVENTION

Thin film filters, ring resonators and spliced fibers, however, each have drawbacks. Thin film filters require free space optics to form a beam for transmission through the filter material and then to couple the beam back into optical fiber. It is also difficult to achieve narrow full spectral ranges due to thickness limitations of grown films. With ring resonators, it is also difficult to achieve the full spectral range due to the required bend radii. As the bend radii decrease the losses increase in the ring resonator. The fiber Mach-Zehnder devices are complicated to assemble and the filter line-shape is generally poor due to the lack of poles.

An alternative to thin film filters, ring resonators filters and coupled fibers filters are grating structures fabricated in planar waveguide devices. This technology does not require free space optics as thin film filters and avoids the bend radii/loss tradeoff of ring resonators and avoids the poor filter line-shapes of Mach-Zehnder devices.

Presently proposed devices, however, are limited to “one”-channel add-drop functions, such as conventional add-drop filters, or “all”-channel routing functions, such as multiplex/demultiplex. Some have proposed single-channel photonic filter devices combining superstructure or sampled photonic band gap (PBG) waveguide gratings. These systems, however, do not provide for broadband feedback effects for pole and zero manipulation, and would thus be inapplicable to applications including broadband de-interleaving and broadband spectral slicing.

The invention describes a multiple-channel add-drop photonic device, utilizing superstructure and/or sampled large photonic band-gap waveguide gratings and coupling waveguide structures that are designed to achieve desired add-drop filter functionalities over a large bandwidth. The invention describes the realization of multiple-channel spectral de-interleavers, spectral slicers, and channel-specific spectral filters, with sharp add-drop filter characteristics.

In general, according to one aspect, the invention features a large bandwidth add-drop filter for a planar waveguide device. It comprises at least one coupler that receives an input signal and provides an output signal and at least two grating waveguides having a photonic band gap covering multiple channels of interest, specifically 4 channels or more.

In some embodiments, the gratings have a superstructure grating strength profile to provide a spectral interleaver. In other embodiments, the gratings have a sampled grating strength profile to provide a spectral slicer. In other embodiments, the gratings have a combination of superstructure and sampled grating strength profiles to provide channel-specific filter characteristics.

In an exemplary embodiment, two directional couplers are used. One coupler provides an input port and a drop port and the other provides an add port and a transmission port.

The invention also addresses the problem of integrating the add-drop filtering functionality into one centralized multiple-channel filter structure by utilizing a versatile embodiment providing feedback paths and interference paths for pole and/or zero filter manipulation. The invention addresses the problem of designing multiple-channel spectral de-interleavers, spectral slicers or other channel-specific spectral filters with sharp add-drop filter characteristics.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

FIG. 1 is a schematic of a multi-channel routing filter having two input ports (IN and ADD) and four output ports (DROP, TRANSMISSION, REFLECTION, LEAK), in accordance with the invention;

FIG. 2 is a schematic of a multi-channel routing filter having two input ports (IN and ADD) and four output ports (DROP, TRANSMISSION, REFLECTION, LEAK) and a isle waveguide delay-line, in accordance with the invention;

FIG. 3 is a schematic of a multi-channel routing filter showing the forward and backward propagating modes.

FIG. 4 is a plot of filter spectral response as function of wavelength in nanometers showing the performance of an inventive spectral de-interleaver with 1.6 nm of full spectral range;

FIG. 5 is a plot of grating strength as a function of position in the grating waveguides providing a de-interleaver function;

FIG. 6 is a plot of filter spectral response as function of wavelength in nanometers showing the performance of an inventive Vernier de-interleaver with 16 nm of full spectral range, in accordance with the embodiment of FIG. 1;

FIG. 7 is a plot of filter spectral response as function of wavelength in nanometers showing the performance of an inventive Vernier de-interleaver with 16 nm of full spectral range, in accordance with the embodiment of FIG. 2;

FIG. 8 is a plot of grating strength as a function of position in the grating waveguides for a superstructure grating providing Vernier operation;

FIG. 9 is a plot of filter response as function of wavelength in nanometers showing the performance of a spectral slicer in accordance with the invention, with a single slicing window for the C-band;

FIG. 10 is a plot of filter response as function of wavelength in nanometers showing the performance of a two window spectral slicer in accordance with the invention;

FIG. 11 is a plot of grating strength as a function of position in the grating waveguides showing a sampled grating profile for the slicer; and

FIG. 12 is a schematic of an exemplary embodiment of a multi-channel routing filter for a channel-specific spectral filter in accordance with the invention.

### DETAILED DESCRIPTION OF THE INVENTION

The invention relates to a multi-channel add/drop filter comprised of an input coupling structure, a large photonic band-gap grating with a parameter profile, and an output coupling structure. The grating parameter profile has a specific functional form. The invention employs feedback and interference paths to provide poles and/or zeros for specific filter designs.

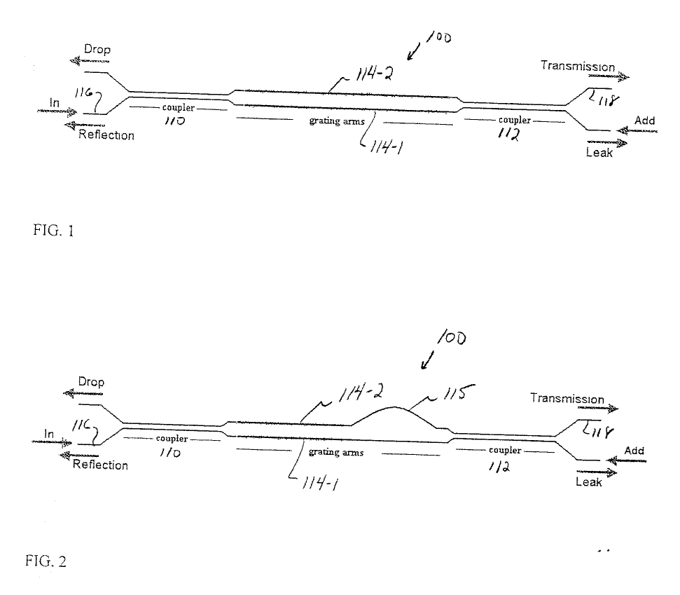

FIG. 1 a schematic of an exemplary multi-channel add/drop,(MCAD) routing filter 100, which has been constructed according to the principles of the present invention.

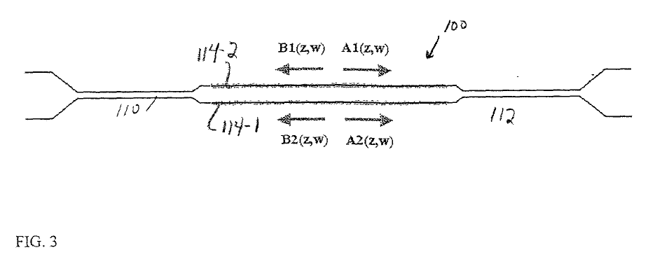

FIG. 2 is a schematic of an alternative design in which the multi-channel add/drop (MCAD) routing filter 100 includes a waveguide delay line 115 in one of the grating arms.

In more detail, relative to both drawings, an input directional coupler 110 and an output directional coupler 112 are connected to opposite ends of two grating waveguide arms 114-1, 114-2. The directional couplers 110, 112 are preferably 50/50 splitter/combiners. The grating waveguide arms 114-1, 114-2 are configured with functional form large photonic band-gap (PBG) gratings, such as superstructure gratings or sampled gratings. The MCAD filter is typically designed to have a high-fidelity spectral response for separating desired groups of channels.

A superstructure waveguide grating is a waveguide grating having a modulated grating strength profile, including variation of amplitude and/or phase and/or periodicity of the grating pattern. A sampled waveguide grating is a waveguide grating in which the coupling strength is modulated in a binary fashion, with each grating section having a detuned or different pass-band frequency. Both superstructure gratings and sampled gratings produce a multiple pass-band filter characteristic.

The MCAD filter 100 has two input ports, labeled IN and ADD, and four output ports, labeled TRANSMISSION, DROP, LEAK, and REFLECTION. The MCAD filter 100 drops a first set of desired channels to the DROP port without significantly affecting a second set of remaining channels, which are routed to the TRANSMISSION port. The ADD port is typically used to add a different first set of channels for output through the TRANSMISSION port. In this way, the MCAD filter 100 provides add-drop functionality for the first set of desired channels.

Alternatively, the ADD port is used to add a different second set of remaining channels to the DROP port signal, in other implementations.

Each grating waveguide arm 114-1, 114-2 has a PBG grating that provides a photonic band-gap covering the spectral range of desired optical channels. The photonic band-gap of the PBG gratings is broadband so that the MCAD filter can operate on multiple channels, simultaneously.

By way of background, a grating waveguide is a waveguide with a periodic modulation of refractive index. The periodic modulation of refractive index produces a dielectric lattice structure. The spatial period Λ of the grating modulation and the effective index n_{eff} of the waveguide define the optical wavelength λ_{B} where Bragg reflection of the electromagnetic wave occurs, λ_{B}=2Λn_{eff}. At this Bragg-wavelength the electromagnetic wave is forbidden to propagate along the waveguide due to the Bragg reflection from the lattice structure of the grating. If the refractive index modulation is strong enough the forbidden wavelength extends to a range of forbidden wavelengths, resulting in a gap of forbidden propagation wavelengths, called photonic band-gap. In this range of forbidden propagation wavelengths no electro-magnetic waves can forward-propagate due to the Bragg reflection from the strong lattice structure of the grating. The range of forbidden propagation wavelengths Δλ_{PBG}, also called band-gap width or stop-band width, is related to the strength κ of Bragg reflection (grating strength) and to the group index n_{g} of the waveguide, Δλ_{PBG}=κλ_{B}²/πn_{g}.

The photonic band-gap is said to be large if the band-gap width Δλ_{PBG} covers multiple optical channels, or extends over several, preferably more than four and typically more than eight, units of channel spacing Δλ_{CS} such that Δλ_{PBG}>>Δλ_{CS}. This translates to about 3.2 to 6.4 nanometers, or more, in a system with 0.8 nanometer (nm) channel spacings. Alternatively, this translates to about κ=0.006 μm⁻¹ to κ=0.013 μm⁻¹, or more, of grating strength for silica waveguides designed to operate at about 1550 nm of wavelength.

The PBG gratings 114-1, 114-2 provide Bragg reflection that couples the forward-propagating wave to the backward propagating wave, thus reflecting some frequencies to the DROP port. The coupling strength per unit length is represented by the grating strength, κ(Z). The grating strength is position-dependent and has a specific functional form to obtain desired filtering operations, such as spectral de-interleaving and spectral slicing. In the PBG grating devices 114-1, 114-2, the grating strength, κ, the central optical frequency, ωₒ, the waveguides side-coupling strength, μ, and the waveguide group velocity, v_{g}, profiles typically have functional forms. The functional form of each parameter profile is preferably the same for both of the PBG grating arms 114-1, 114-2 in the filter 100.

The spectral response of the MCAD filter 100 can be calculated using coupled-mode theory. The coupled equations of the device are

dA₁(zω)/dz=−j[(ω−ωₒ(z))/v_{g1}(ω)]A₁−jμ(z,ω)A₂+κₙ(z)e^{1Φ(2)}B₁

dB₁(z,ω)/dz=+j[(ω−ωₒ(z))/v_{g1}(ω)]B₁+jμ(z,ω)B₂+κₙ*(z)e^{-1Φ(z)}A₁

dA₂(z,ω)/dz=−j[(ω−ωₒ(z))/v_{g2}(ω)]A₂−jμ(z,ω)A₁+κₙ(z)e^{1Φ(z)}B₂

dB₂(z,ω)/dz=−j[(ω−ωₒ)(z))/v_{g2}(ω)]B₂+jμ(z,ω)B₁+κₙ*(z)e^{-1Φ(z)}A₂

where A₁ and B₁ represent the forward-propagating wave and the backward-propagating wave in waveguide 114-2, A₂ and B₂ represent the forward-propagating wave and the backward-propagating wave in waveguide 114-1, as illustrated in FIG. 3. FIG. 3 is a schematic of the multi-channel add/drop routing filter 100 showing the forward and backward propagating modes.

Variable ωₒ(z) is the position dependent central optical frequency of the MCAD filter and v_{g}(ω) is the group velocity of the waveguides at the frequency ω. The Bragg frequency, ωₒ(z), is related to the Bragg wavelength as ωₒ=2πc/λ_{B} and the group velocity is v_{g}=c/n_{g}, where c is the speed of light and n_{g} is the group index of the waveguide. μ(z,ω) is the position and frequency dependent evanescent coupling strength between the two waveguides in the directional couplers. κ(z)e^{iΦ(z)} represents the coupling strength, where κ(z) is the position-dependent grating strength and Φ(z) is the position-dependent grating phase.

The spectral response of the MCAD filter 100 is obtained by integrating the coupled equations over the total length, z=L, of the device. In these equations, A₁(L,ω) describes the TRANSMISSION spectra, B₁(0,ω) describes the DROP spectra, A₂(L,ω) describes the LEAK spectra, B₂(0,ω) describes the REFLECTION spectra, A₂(0, ω) describes the IN spectra, and B₂(L,ω) describes the ADD spectra.

The MCAD filter can perform a variety of operations by using gratings with different parameter profiles.

Spectral De-interleaver

By using superstructure photonic band-gap (PBG) gratings in the grating waveguide arms 114-1, 114-2, a spectral de-interleaver operation is achieved. The superstructure PBG gratings have a periodic grating strength profile.

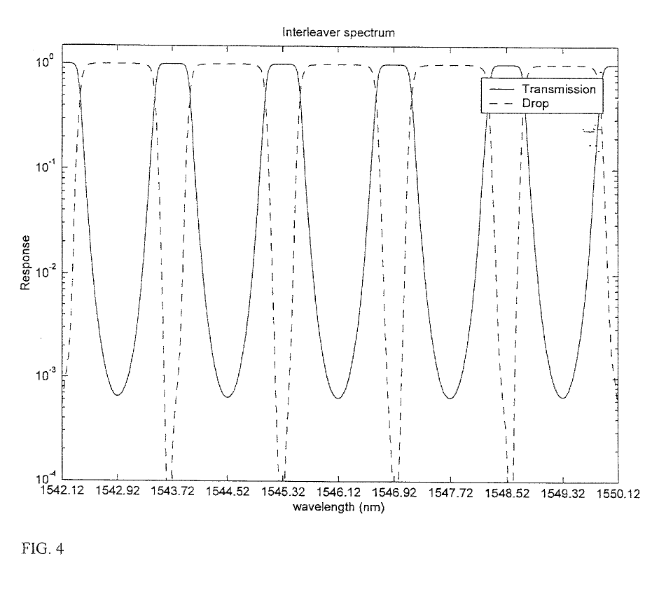

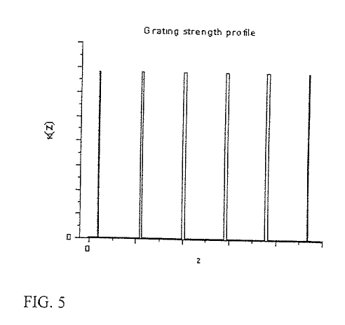

FIG. 4 is a plot of filter spectral response as function of wavelength in nanometers showing the performance of an inventive spectral de-interleaver with 1.6 nm of full spectral range. It has a high-fidelity comb-like spectral response for separating alternating channels over a bandwidth determined by the grating bandgap. In this example, the filter covers more than 10 optical channels and the channel spacing is 0.8 nanometers (nm). In other embodiments with larger grating bandgaps, the filter covers more than 40 channels, or greater than about 30 nm. Even numbered channels are routed to the DROP port without affecting odd numbered channels, which are routed to the TRANSMISSION port. The ADD port can be used to add a set of different even channels into the TRANSMISSION port signal. The de-interleaver, therefore, provides add-drop functionality for the even channels. Alternatively, the odd channels can be dropped instead by using a different central optical frequency, ω(z), to shift the channels by one channel spacing.

FIG. 5 is an example plot of grating strength as a function of position in the grating waveguides providing a de-interleaver function. FIG. 5 shows the grating strength κ(z) of the gratings 114-1, 114-2 as a function z axis position. It has a binary functional form, where the periodicity of the binary function is called the superperiod, Aₛ. The superperiod of the grating strength κ(z) produces multiple resonant longitudinal modes with a full spectral range of

Δλ_{FSR}=λ_{B}²/2n_{g}Λ_{S},

where λ_{B} is the Bragg wavelength and n_{g} is the group index. The Bragg frequency is the central optical frequency of the de-interleaver and is constant over the length of the filter 100. The grating strength profile includes a tapering of the length of the grating sections to provide the desired coupling between the cavities for optimally flat-top filter characteristics. The grating strength profile is the same for both of the superstructure PBG grating arms in the filter. The de-interleaver filter is not restricted to the number of cavities, the length and the strength profile shown in FIG. 5.

In the response of a de-interleaver device shown in FIG. 4, Δλ_{FSR}=1.6 nm and ωₒ/2π=193.0 THz (λ_{B}=1546.12 nm), the grating strength is κ=0.07 μm⁻¹ and the normalized inputs are A₂(0,ω)=1 and B₂(L,ω)=0.

Vernier De-interleaver

The binary function grating strength profile is not limited to a single superperiod. In other embodiments, multiple superperiods are designed to provide Vernier operation where partial de-interleaving is performed. The Vernier de-interleaver consists of a multiple cavity device having multiple resonant longitudinal modes with complete resonant dropping operating only at every Nth values of narrowest full spectral range, N being the common denominator of the full spectral ranges of the cavities.

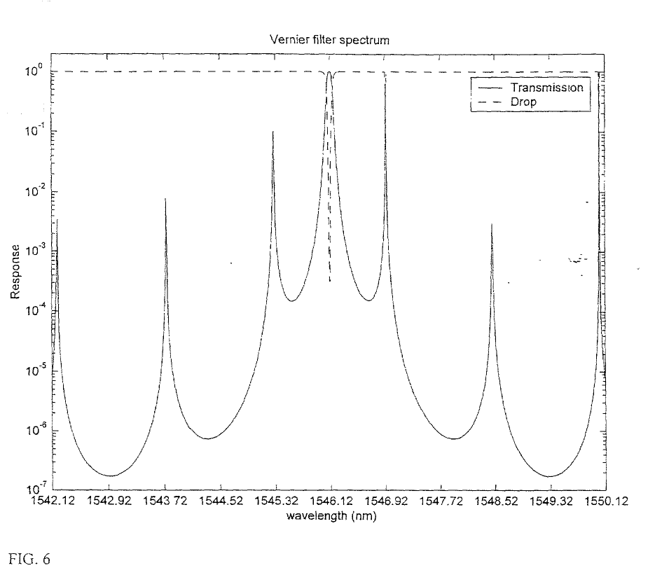

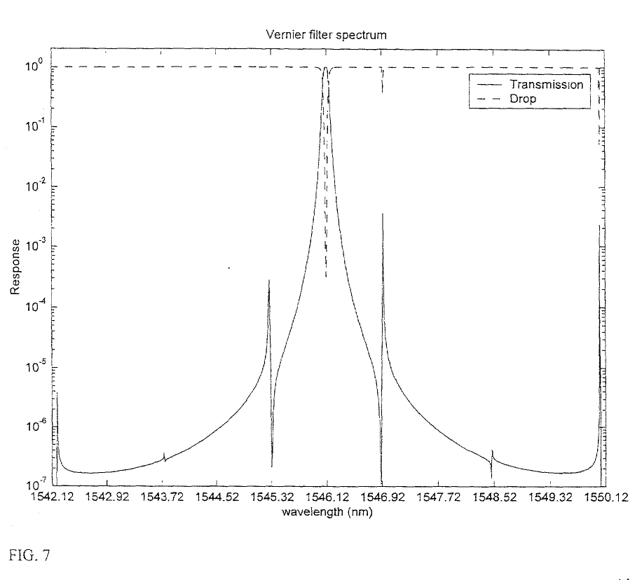

FIG. 6 is a plot of filter spectral response as function of wavelength in nanometers showing the performance of an inventive Vernier de-interleaver with 16 nm of full spectral range, in accordance with the embodiment of FIG. 1. FIG. 6 shows for example the filter function of a Vernier de-interleaver having 3 resonant cavities; 2 cavities with 1.6 nm of fall spectral range and 1 cavity with 16 nm of full spectral range. As a result of this 1-to-10 full spectral range ratio, complete resonant drop occurs at every 16 nm while partial drops occur at every 1.6 nm. Suppression of these partial drops is possible by using the embodiment of FIG. 2; the delay-line can provide zeros with a full spectral range of 1.6 nm to suppress some of the poles of the drop response, resulting in an improved spectrum as shown in FIG. 7.

FIG. 7 is a plot of filter spectral response as function of wavelength in nanometers showing the performance of an inventive Vernier de-interleaver with 16 nm of full spectral range, in accordance with the embodiment of FIG. 2. In this example, the Vernier de-interleaver routes every 10^{th} channel to the DROP port and the other 9 channels go to the TRANSMISSION port. The ADD port can be used to add a set of different 10^{th} channels into the TRANSMISSION port signal, providing add-drop functionality to these specific channels.

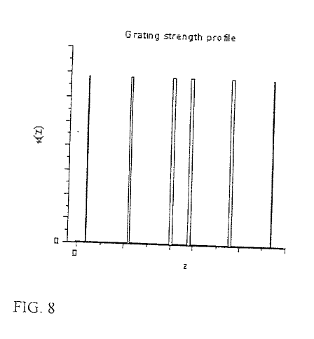

The grating strength κ(z) of the gratings of the Vernier device has a binary functional form, as shown in FIG. 8, with more than one superperiod. FIG. 8 is an example plot of grating strength as a function of position in the grating waveguides for a superstructure grating providing Vernier operation. The Vernier de-interleaver filter is not restricted to the number of cavities, the superperiods, the length and the strength profile shown, in FIG. 8.

Spectral Slicer

By using one or many apodized sampled photonic band-gap (PBG) gratings in the grating waveguide arms, a spectral slicer, or band-pass filter, operation is achieved.

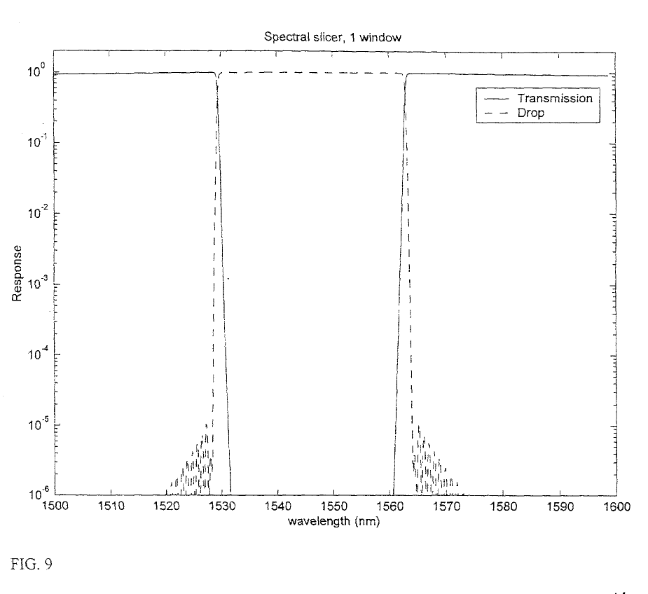

FIG. 9 is a plot of filter response as function of wavelength in nanometers showing the performance of a spectral slicer, with a single slicing window for the C-band. FIG. 9 shows the spectral response of the MCAD filter 100 for slicer operation. It has a high-fidelity bandpass spectral response for separating ranges of multiple sequential/adjacent channels. In the illustrated example, the slicer covers about 32 nm in the C-band, corresponding to about 40 channels based on a channel separation of 0.8 nm. The slicer drops a number of adjacent channels in desired spectral windows (sliced channels), without affecting neighboring channels (non-sliced channels), and routes the desired sliced channels to the DROP port. The non-sliced channels are directed to the TRANSMISSION port. The ADD port can be used to add a set of different sliced channels into the TRANSMISSION port signal. Therefore, the slicer provides add-drop functionality for the channels in the sliced window.

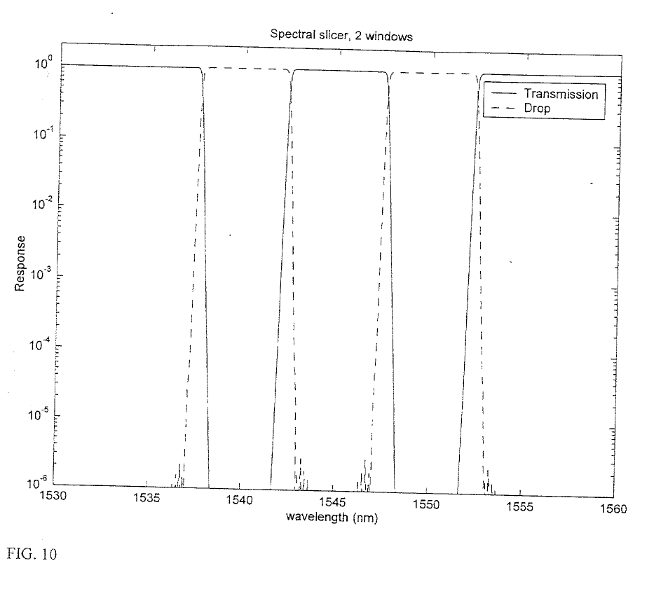

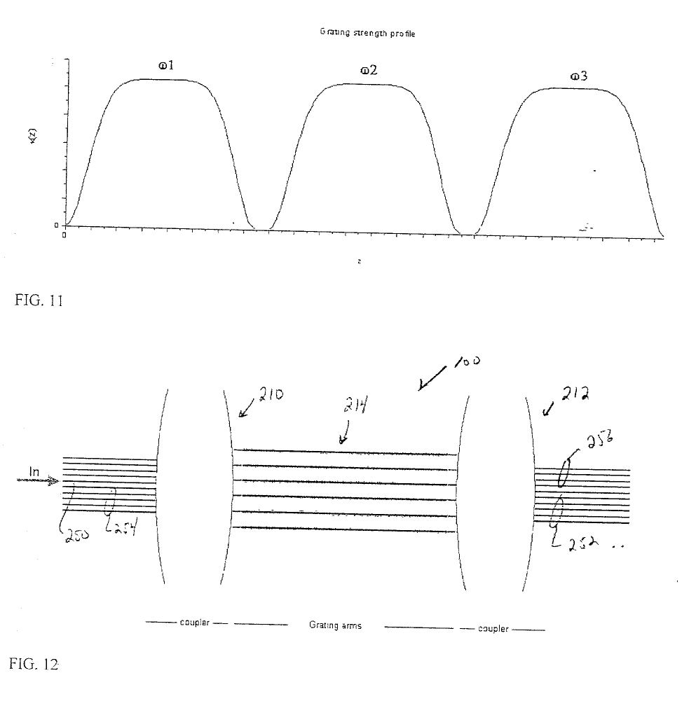

The spectral slicer can be designed to drop more than one window. FIG. 10 is a plot of filter response as function of wavelength in nanometers showing the performance of a two window (each 5 nm wide) spectral slicer in accordance with the invention. The gratings have a sampled functional form to provide multiple filter pass-bands tuned at central frequencies of interest ω₁, ω₂, ω₃, etc., as shown in FIG. 1 1. FIG. 11 is an example plot of grating strength as a function of position in the grating waveguides showing a sampled grating profile for the slicer. The sampled PBG grating can provide multiple windows of different spectral widths, Δλ_{PBG}, at different Bragg wavelengths, λ_{B}. The spectral width Δλ of a sliced window depends on the magnitude of the sampled grating strength, κ, as

Δλ=Δλ_{PBG}=κλ_{B}²/πn_{g}.

The Bragg frequency is the central optical frequency of each slicer pass-bands and is position-dependent due to the sampled profile of the grating. The grating strength profile includes an apodisation of each grating sample section to provide sharp filter characteristics with strong spectral side-lobe rejection. The spectral slicer filter is not restricted to the number, the length and the strength profile of the gratings shown in FIG. 11.

Filter Switching

In some implementations, the MCAD filter 100 is switched by dynamically changing the group velocities of the grating waveguides. The grating waveguides have operator-dependent group velocities v_{g}=v_{g}(F) for switching applications, such as thermo-optic, electro-optic, or other operations changing the dielectric properties of the waveguides, represented by the operator F. The group velocity of the waveguides is a function of position and operation, v_{g}=v_{g}(z,F). For example, thermo-optically changing the group velocities of the delay-line of the embodiment of FIG. 2 by the inclusion of a heater over the delay line 115 will switch the output signal from the transmission port to the leak port, and vice versa.

Thermo-optic switching can also be used to switch between the two sets of de-interleaved channels in the de-interleaver. By heating all of the gratings, the spectral response can be shifted by one channel, so that the dropped channels become the transmitted channels, and vice versa.

A line-shape control of the de-interleaver can also be obtained by changing the coupling between the resonant cavities. This can be done by changing the dielectric properties of the resonator material, such as a change of the group index n_{g} of the cavity waveguides. A change of waveguide index Δn will produce a change of optical phase Δφ in every cavity, such that Δφ=πλΔn/n_{g}Δλ. For example, the cavities of the de-interleaver can be put out-of-phase by having quarter-wave shifts of Δφ=π/2 between the cavities, such as alternating the optical phases of the cavities with a phase configuration of Δφ=[+π/4, −π/4, +π/4, −π/4, +π/4, . . . ]. The result will be the cancellation of the de-interleaver spectrum at the channels of interest.

N×M Filter

FIG. 12 is a schematic of an exemplary embodiment of a multi-channel routing filter 100 for a channel-specific spectral filter in accordance with the invention. An input coupling structure 210 is connected to one side of an array of grating waveguide arms 214 and an output coupling structure 212 is connected to the opposite side of the grating waveguide arms 214.

The channel-specific spectral filter has one input port (In) 250 for the WDM signal, has N (one or more) input ports 252 for the added channels, has M (one or more) output ports 254 for the dropped channels, and has one or more output ports 256 for the multiplexed channels. The device 100 provides add-drop functionality for the dropped channels.

The grating waveguide arms 114 are PBG grating waveguides providing a photonic band-gap large enough to cover the spectral range of the optical channels to be added and/or dropped. The grating band-gap covers preferably 4 or more channels.

The PBG grating waveguides 214 are typically either superstructure or sampled PBG gratings, or both. The PBG gratings can have multiple phase shifts, multiple pass-bands, multiple group velocities, and multiple grating strengths.

The interference effect is provided by coherent coupling between the input/output waveguides and the grating arms, and can be achieved using multi-waveguide directional couplers or multi-mode interference waveguides or diffracting slab waveguides.

Although the present invention has been shown and described with respect to several preferred embodiments thereof, various changes, omissions and additions to the form and detail thereof, may be made therein, without departing from the spirit and scope of the invention.

What is claimed is:

1. A large bandwidth add-drop filter for a planar waveguide device comprising:
at least one coupler receiving an input signal and providing an output signal; and
at least two grating waveguides having a photonic band-gap covering at least 4 optical channels.

2. An add-drop filter as claimed in claim 1, wherein the photonic band-gap covers at least 8 optical channels.

3. An add-drop filter as claimed in claim 1, wherein the grating waveguides have a superstructure grating strength profile.

4. An add-drop filter as claimed in claim 1, wherein the grating waveguides have a sampled grating strength profile.

5. An add-drop filter as claimed in claim 1, wherein at least one coupler comprises a directional coupler.

6. An add-drop filter as claimed in claim 1, wherein at least one coupler comprises multi-mode interference waveguides.

7. An add-drop filter as claimed in claim 1, wherein at least one coupler comprises diffracting slab waveguides.

8. An add-drop filter as claimed in claim 1, wherein at least one coupler comprises diffracting slab waveguides. An add-drop filter as claimed in claim 1, wherein one or more grating arms comprises delay-line waveguides.

9. An add-drop filter as claimed in claim 1, further comprising two couplers, in which a first coupler provides an input port and a drop port and a second coupler provides an add port and a transmission port.

10. An add-drop filter as claimed in claim 1, wherein the grating waveguides have superstructure grating strength profiles providing spectrally periodic transmission bands a aligned with optical channels.

11. An add-drop filter as claimed in claim 9, wherein the superstructure has one or multiple superperiods.

12. An add-drop filter as claimed in claim 1, wherein the grating waveguides have sampled grating strength profiles providing a window transmission function, covering a band of optical channels.

13. An add-drop filter as claimed in claim 1, wherein the grating waveguides have sampled grating strength profiles providing two or more window functions, each covering bands of optical channels.

14. An add-drop filter as claimed in claim 1 further comprising a grating tuner for changing a group velocity of one or more of the grating waveguides.

15. An add-drop filter as claimed in claim 13, wherein the grating tuner heats at least one of the grating waveguides.

16. A filter for a planar waveguide device comprising:
at least one coupler receiving an input signal and providing an output signal; and
at least two grating waveguides having a grating strength of higher than about κ=0.006 μm⁻¹.

17. A filter for a planar waveguide device comprising:
at least one coupler receiving an input signal and providing an output signal; and
at least two grating waveguides having a grating strength of higher than about κ=0.013 μm⁻¹.
